(19) United States
(12) Patent Application Publication
(10) Pub. No.: US 2020/0380460 A1
(43) Pub. Date: Dec. 3, 2020

(54) LOADING SUPPORT SYSTEM, LOADING SUPPORT METHOD, AND LOADING SUPPORT PROGRAM

(71) Applicant: TOYOTA JIDOSHA KABUSHIKI KAISHA, Toyota-shi (JP)

(72) Inventors: Yu NISHIKATA, Tokyo (JP); Masao Hitomi, Toyota-shi (JP); Kousuke Matsuyama, Tokyo (JP); Maiko Eguchi, Tokyo (JP); Seiji Kuroki, Tokyo (JP); Hiroaki Kawahara, Tokyo (JP)

(73) Assignee: TOYOTA JIDOSHA KABUSHIKI KAISHA, Toyota-shi (JP)

(21) Appl. No.: 16/880,284

(22) Filed: May 21, 2020

(30) Foreign Application Priority Data
May 30, 2019 (JP) 2019-101016

(51) Int. Cl. G06Q 10/08; G06Q 50/28

(52) U.S. Cl. CPC G06Q 10/0832; G06Q 10/0835; G06Q 50/28; G06Q 10/08345; G06Q 10/0833

(57) ABSTRACT

A loading support device includes an acquisition unit configured to acquire load information in which a load ID for identifying the load is associated with desired information relevant to transportation of the load, the desired information including at least one transportation quality parameter; an extraction unit configured to, while referring to load space information, in which a load space ID, assigned to each of a plurality of load spaces, is associated with a load space parameter of each load space, extract the load space having the load space parameter corresponding to the transportation quality parameter; and an output unit configured to output loading information in which the load ID of the load is associated with the load space ID of the load space.

### TECHNICAL FIELD

The present disclosure relates to a loading support system, a loading support method, and a loading support program.

### CROSS-REFERENCE TO RELATED APPLICATION

This application claims the benefit of priority from Japanese Patent Application No. 2019-101016, filed May 30, 2019, the entire contents of which are incorporated herein by reference.

### BACKGROUND

When a load is transported by a vehicle, disposition of the load in a load compartment is determined at discretion of a driver based on a shape, a size, a transport distance and the like of the load. Regarding the disposition of the load in the load compartment, there is known a technique for carrying an article to any of blocks acquired through virtual division (for example, see Japanese Unexamined Patent Publication No. 2009-12834).

### SUMMARY

When a load is transported by a vehicle, there is a case where a shipper desires to perform transportation at an appropriate transportation quality including a transportation fee based on a nature or the like of the load. However, in the related art, the load is loaded at discretion of a driver as a transporter, and thus the shipper cannot specify the transportation quality. On the other hand, a carrying location of the load is determined at the discretion of the driver, and thus labor and time are required for the determination.

An object of the present disclosure is to enable the load to be transported at a desired transportation quality for the shipper, and to reduce loading time and labor required for the transporter.

According to an aspect of the present disclosure, there is provided a loading support system, which supports loading of a load into a load compartment of a vehicle, the loading support system including an acquisition unit configured to acquire load information in which a load ID for identifying the load is associated with desired information relevant to transportation of the load, the desired information including at least one transportation quality parameter relevant to a transportation quality of the load; an extraction unit configured to, while referring to load space information, in which a load space ID, assigned to each of a plurality of load spaces formed by performing virtual division on a carrying space in which the load is carried on the load compartment, is associated with a load space parameter which is a parameter relevant to a transportation quality of each load space, extract the load space having the load space parameter corresponding to the transportation quality parameter included in the desired information of each load; and an output unit configured to output loading information in which the load ID of the load is associated with the load space ID of the load space extracted by the extraction unit based on the desired information of the load.

According to another aspect of the present disclosure, there is provided a loading support method in a loading support system which supports loading of a load into a load compartment of a vehicle, the loading support method including acquiring load information in which a load ID for identifying the load is associated with desired information relevant to transportation of the load, the desired information including at least one transportation quality parameter relevant to a transportation quality of the load; while referring to load space information, in which a load space ID, assigned to each of a plurality of load spaces formed by performing virtual division on a carrying space in which the load is carried on the load compartment, is associated with a load space parameter which is a parameter relevant to a transportation quality of each load space, extracting the load space having the load space parameter corresponding to the transportation quality parameter included in the desired information of each load; and outputting loading information in which the load ID of the load is associated with the load space ID of the load space extracted by the extracting based on the desired information of the load.

According to still another aspect of the present disclosure, there is provided a loading support program for causing a computer to function as a loading support system which supports loading of a load into a load compartment of a vehicle, the loading support program causing the computer to realize an acquisition function of acquiring load information in which a load ID for identifying the load is associated with desired information relevant to transportation of the load, the desired information including at least one transportation quality parameter relevant to a transportation quality of the load; an extraction function of, while referring to load space information, in which a load space ID, assigned to each of a plurality of load spaces formed by performing virtual division on a carrying space in which the load is carried on the load compartment, is associated with a load space parameter which is a parameter relevant to a transportation quality of each load space, extracting the load space having the load space parameter corresponding to the transportation quality parameter included in the desired information of each load; and an output function of outputting loading information in which the load ID of the load is associated with the load space ID of the load space extracted by the extraction function based on the desired information of the load.

According to the above aspects, the desired information including the transportation quality parameter relevant to a transportation target load is acquired based on an input of a user who is a shipper, and the load space having the load space parameter corresponding to the acquired transportation quality parameters is extracted. Therefore, it is possible to assign the load space having a transportation quality desired for the shipper to the transportation target load. In addition, since the loading information in which the load ID of the load is associated with the load space ID of the load space assigned to the load is output, the transporter refers to the loading information, and thus reduction in time and labor for a loading work is realized.

In the loading support system according to the other aspect, the desired information may include the plurality of transportation quality parameters, and the extraction unit may be configured to extract the load space having the load space parameter corresponding to each of the plurality of transportation quality parameters included in the desired information.

According to the aspect, the plurality of transportation quality parameters are included in the desired information, and the load space having the load space parameter corresponding to each of the transportation quality parameters is extracted, and thus it is possible to assign the load space, in which a transportation quality of a plurality of items desired for the shipper is satisfied, to the transportation target load.

In the loading support system according to the other aspect, the desired information may include, as the transportation quality parameter, at least one of a temperature parameter indicating a magnitude of a temperature change during transportation, a vibration parameter indicating a magnitude of vibration during the transportation, and a fee parameter indicating a level of a transportation fee, and the load space parameter may include a parameter corresponding to the transportation quality parameter.

According to the aspect, the temperature parameter, the vibration parameter, and the fee parameter may be included in the desired information as the transportation quality parameter, and thus it is possible to assign the load space in which the transportation quality relevant to a temperature, a vibration, and a fee desired for the shipper is satisfied, to the transportation target load.

In the loading support system according to the other aspect, the desired information may include distance information relevant to a transportation distance of the load, the load space information may include information according to a distance from a carrying-in and out location of the load compartment of each load space, and the extraction unit may be configured to, when a transportation distance of a first load of a plurality of loads is longer than a transportation distance of the second load of the plurality of loads, extract respective load spaces of the first load and the second load such that a distance from a carrying-in and out location of a load space extracted with respect to the second load becomes shorter than a distance from a carrying-in and out location of a load space extracted with respect to the first load.

According to the aspect, the load space close to the carrying-in and out location is assigned to a load having a shorter transportation distance, with the result that a labor, such as a change in disposition of the load in the load compartment in an unloading location or the like, is reduced, and thus it is possible to reduce the loading time and labor required for the transporter.

In the loading support system according to the other aspect, the acquisition unit may be configured to acquire information about a loading location and an unloading location of the load, and may acquire the distance information based on the information about the loading location and the unloading location.

According to the aspect, even in a case where the distance information is not directly input, information about the transport distance of the load is easily acquired.

According to one aspect of the present disclosure, it is possible to transport the load with the desired transportation quality for the shipper, and to reduce the loading time and labor required for the transporter.

### BRIEF DESCRIPTION OF THE DRAWINGS

FIG. 1 is a diagram illustrating a device configuration of a loading support system including a loading support device according to an embodiment.

FIG. 2 is a block diagram illustrating a functional configuration of the loading support device.

FIG. 3 is a diagram illustrating a hardware configuration of the loading support device.

FIG. 4 is a diagram illustrating an example of a transportation quality parameter setting screen.

FIG. 5 is a diagram illustrating an example of a configuration of load information and data stored therein.

FIG. 6A is a diagram schematically illustrating an example of a load space formed in a carrying space of a load compartment.

FIG. 6B is a diagram schematically illustrating an example of a load space formed in a carrying space of a load compartment.

FIG. 7 is a diagram illustrating an example of a configuration of load space information and an example of data stored therein.

FIG. 8 is a diagram illustrating an example of a configuration of loading information and data stored therein.

FIG. 9 is a flowchart illustrating processing content of a loading support method performed in the loading support system.

FIG. 10 is a diagram illustrating a configuration of a loading support program.

### DETAILED DESCRIPTION

Hereinafter, an embodiment of the present disclosure will be described in detail with reference to the accompanying drawings. Note that, in description of the drawings, the same or equivalent elements will be denoted by the same reference numerals, and description thereof will not be repeated.

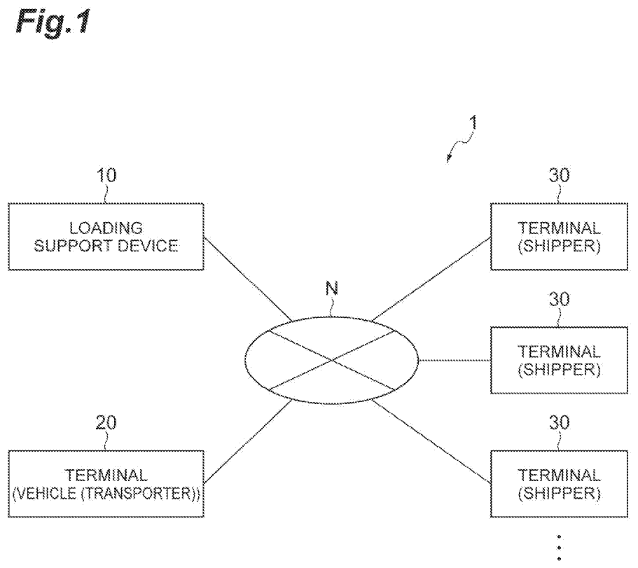

FIG. 1 is a diagram illustrating a device configuration of a loading support system including a loading support device according to the embodiment. A loading support system 1 illustrated in FIG. 1 includes a loading support device 10, a terminal 20 possessed by a transporter or mounted on a vehicle, and a terminal 30 of a shipper. The loading support device 10, the terminal 20, and the terminal 30 can communicate with each other through a network N. The network N is a wireless network. The loading support device 10 constitutes the loading support system that supports loading of a load into a load compartment of the vehicle. Note that, although FIG. 1 illustrates two terminals 20 and three terminals 30, the number is not limited thereto.

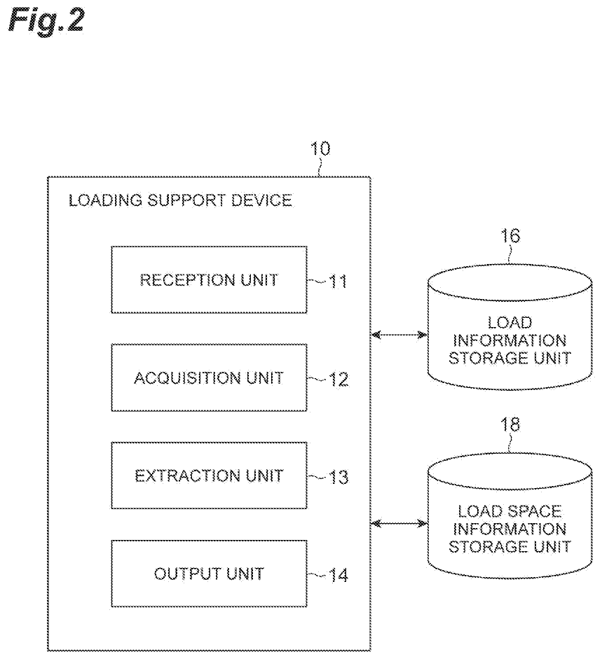

FIG. 2 is a block diagram illustrating a functional configuration of the loading support device 10. The loading support device 10 includes, for example, a computer such as a server. As illustrated in FIG. 2, the loading support device 10 of the embodiment functionally includes a reception unit 11, an acquisition unit 12, an extraction unit 13, and an output unit 14. In addition, each functional unit of the loading support device 10 is configured to be able to access storage means such as a load information storage unit 16 and a load space information storage unit 18. The load information storage unit 16 and the load space information storage unit 18 may be constituted in the loading support device 10, or may be constituted as another device on an outside of the loading support device 10.

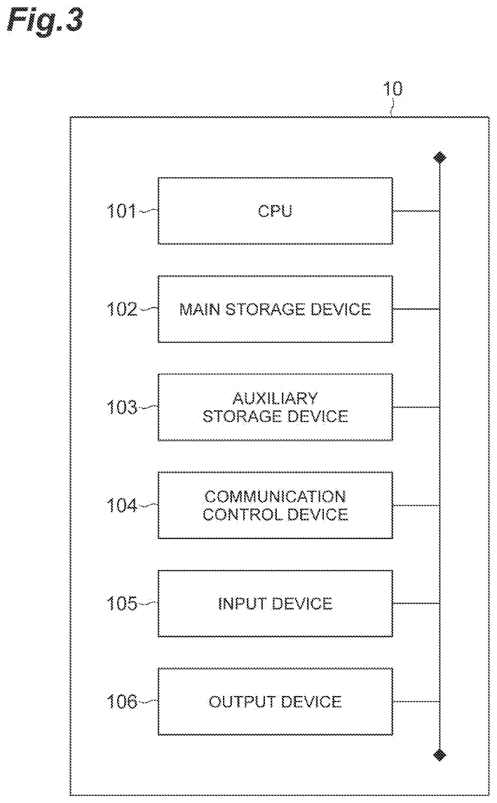

FIG. 3 is a diagram illustrating a hardware configuration of the loading support device 10. As illustrated in FIG. 3, the loading support device 10 is physically constituted as a computer system which includes a CPU 101, a main storage device 102 including memories such as a RAM and a ROM, an auxiliary storage device 103 including a hard disk and the like, and a communication control device 104, and the like. The loading support device 10 may further include an input device 105, such as a keyboard, a touch panel, and a mouse which are input devices, and an output device 106 such as a display.

Each function illustrated in FIG. 2 is realized by reading predetermined computer software on hardware, such as the CPU 101 and the main storage device 102 illustrated in FIG. 3, operating the communication control device 104 and the like under a control of the CPU 101 and by reading and writing data from and to the main storage device 102 and the auxiliary storage device 103. Data and databases required for processing are stored in the main storage device 102 and the auxiliary storage device 103. Note that, the terminals 20 and 30 may be also constituted as the computer system having the hardware configuration as illustrated in FIG. 3. Note that, in the embodiment, although each of the functional units 11 to 14 is constituted in the loading support device 10, each of the functional units 11 to 14 may be constituted to be distributed to a plurality of computers. In addition, a part of each of the functional units 11 to 14 may be constituted in the terminal 20 or the terminal 30.

A device constituting the terminal 20 is not limited, and, for example, may be a computer terminal installed in the vehicle or a portable terminal such as a high-performance mobile phone (smartphone), a tablet computer, a mobile phone, or a Personal Digital Assistant (PDA). In addition, the device constituting the terminal 30 is not limited, and may be a stationary computer device or the portable terminal such as the high-performance mobile phone (smartphone), the tablet computer, the mobile phone, or the PDA.

Each of the functional units of the loading support device 10 will be described with reference to FIG. 2. The reception unit 11 receives, as load information, input of desired information by a user who is a shipper. The desired information is information including content of desire of the shipper regarding transportation of the load, and includes at least one transportation quality parameter relevant to a transportation quality of the load.

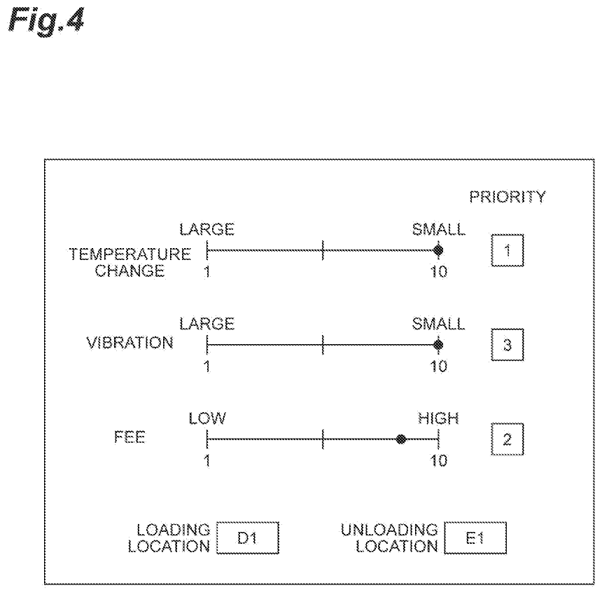

FIG. 4 is a diagram illustrating an example of a transportation quality parameter setting screen in the terminal 30 of the shipper. In the example illustrated in FIG. 4, a temperature parameter, a vibration parameter, and a fee parameter are set as the transportation quality parameter. The temperature parameter indicates a magnitude of a temperature change during transportation. The vibration parameter indicates a magnitude of a vibration during the transportation. The fee parameter indicates a level of a transportation fee. In the example illustrated in FIG. 4, as the transportation quality parameter, a temperature parameter of “10”, a vibration parameter of “10”, and a fee parameter of “8” are set.

In addition, it is possible to set a priority for each transportation quality parameter. The priority indicates a degree to which each parameter should be prioritized in extraction and assignment of a load space which will be described later. In the example illustrated in FIG. 4, a priority of “1” is set for the temperature parameter, a priority of “3” is set for the vibration parameter, and a priority of “2” is set for the fee parameter.

In addition, a loading location and an unloading location of the load may be input on the setting screen. In the example illustrated in FIG. 4, a loading location “D1” and an unloading location “E1” are set.

The reception unit 11 receives the desired information of each load input on the setting screen and transmitted from the terminal 30. Further, the reception unit 11 associates the received desired information and the like with a load ID for identifying the load, and stores the desired information and the like, as the load information, in the load information storage unit 16. The load information storage unit 16 is the storage means for storing the load information in which the load ID is associated with the desired information and the like.

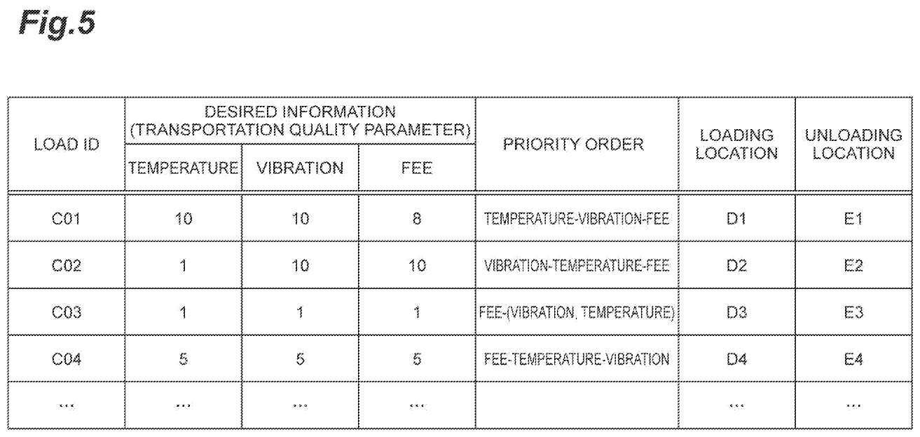

FIG. 5 is a diagram illustrating an example of a configuration of the load information and data included therein. The load information includes information such as the desired information, a priority order, the loading location, and the unloading location information, which are associated with the load ID for identifying each load. The desired information includes, as the transportation quality parameter, the temperature parameter, the vibration parameter, and the fee parameter. For example, load information of a load ID “C01” includes desired information in which a temperature parameter of “10”, a vibration parameter of “10”, and a fee parameter of “8” are set as the transportation quality parameter, and information indicating a priority order “1. temperature-2. vibration-3. Fee”, a loading location of “D1” and an unloading location of “E1”.

The acquisition unit 12 acquires the load information in which the load ID for identifying the load is associated with the desired information regarding the transportation of the load. In the embodiment, the acquisition unit 12 acquires the load information received by the reception unit 11 and stored in the load information storage unit 16. The load information includes the desired information as described above, and the desired information includes the transportation quality parameter as described above.

The extraction unit 13 extracts a load space having a load space parameter corresponding to the transportation quality parameter included in the desired information of each load. The load space is a space formed by performing virtual division on a carrying space in which the load is carried on the load compartment of the vehicle. In each load space, the load space parameter, which is a parameter relevant to the transportation quality in the transportation of the load, is assigned.

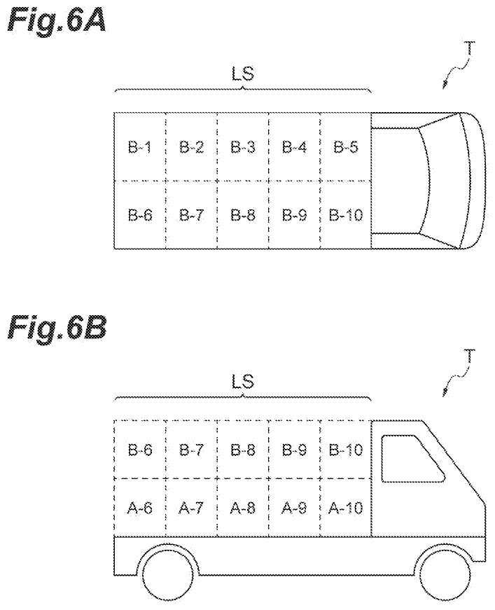

FIG. 6A and FIG. 6B are diagrams schematically illustrating an example of the load space formed in the carrying space of the load compartment. As illustrated in FIG. 6A and FIG. 6B, the carrying space of the load compartment of a vehicle T is virtually divided into a plurality of load spaces. Further, a load space ID (A-1 to 10, B-1 to 10) is assigned to each load space.

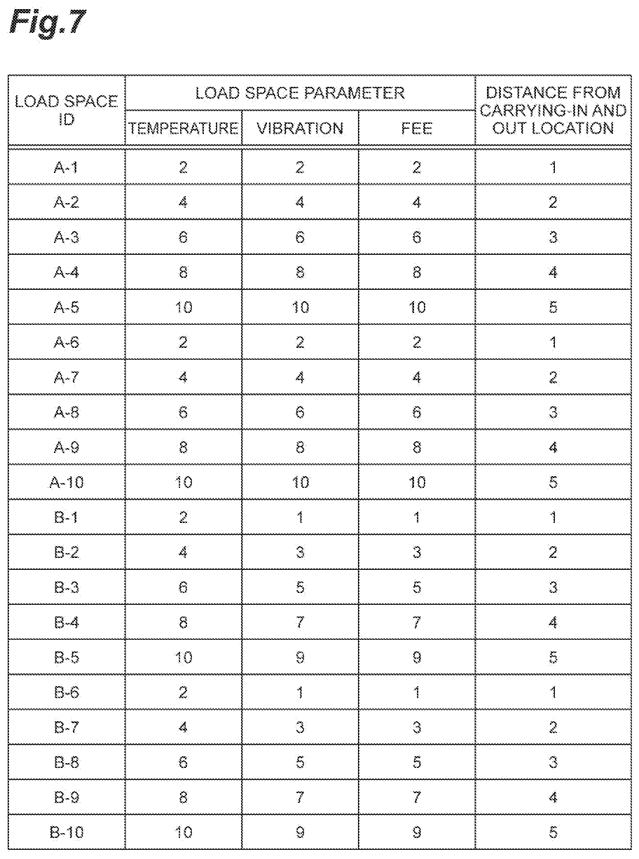

FIG. 7 is a diagram illustrating an example of a configuration of the load space information and data stored therein. The load space information includes the load space parameter associated with the load space ID. In addition, the load space information may further include information indicating a distance from a carrying-in and out location. In the example illustrated in FIG. 7, the load space parameter includes a temperature parameter, a vibration parameter, and a fee parameter to correspond to the transportation quality parameter.

The temperature parameter indicates a magnitude of a temperature change during the transportation, and the larger the number, the smaller the temperature change. The vibration parameter indicates a magnitude of a vibration during the transportation, and the larger the number, the smaller the vibration. The fee parameter indicates a level of the transportation fee, and the larger the number, the higher the fee.

In the example illustrated in FIG. 7, for example, in the load space of the load space ID “A-1”, a temperature parameter of “2”, a vibration parameter of “2”, and a fee parameter of “2” are associated as the load space parameter, and information of a distance “1” from the carrying-in and out location is further associated.

In addition, an example of load space extraction processing by the extraction unit 13 based on one transportation quality parameter will be described. First, the extraction unit 13 acquires the transportation quality parameter included in the desired information of a processing target load. Subsequently, the extraction unit 13 refers to the load space information, and extracts the load space ID having the load space parameter corresponding to the transportation quality parameter. For example, when both the parameters are set according to the same standard, the load space parameter corresponding to the transportation quality parameter may be the load space parameter having a value matching a value of the transportation quality parameter, or the load space parameter having a value in which a difference from the transportation quality parameter is included in a predetermined range.

In addition, when correspondence between both the parameters is set in advance, it is possible to acquire the load space parameter corresponding to the transportation quality parameter according to the set correspondence.

In addition, when the load space having the load space parameter corresponding to the transportation quality parameter does not exist or when the load space having the load space parameter corresponding to the transportation quality parameter is assigned to another load in advance, the extraction unit 13 may extract a load space having a load space parameter of a value closest to the transportation quality parameter among the load spaces each having the load space parameter that does not correspond to the transportation quality parameter.

When the load space is extracted based on a plurality of transportation quality parameters, the extraction unit 13 may first extract the load space based on a first transportation quality parameter to which a high priority is set. When a plurality of load spaces are extracted, the extraction unit 13 may further extract the load space based on a second transportation quality parameter, to which a priority that is high subsequent to the first transportation quality parameter is set, among the plurality of load spaces which are completely extracted.

In addition, when a plurality of load space candidates are extracted with respect to one load by performing the load space extraction processing based on all of one or more transportation quality parameters, the extraction unit 13 may randomly extract one load space from the plurality of load space candidates. In addition, when the correspondence between the information about the distance from the carrying-in and out location of the load space and the distance information relevant to the transportation distance of the load is defined in advance, the extraction unit 13 may extract a load space, which has the information about the distance from the carrying-in and out location corresponding to the distance information on the one load, from the plurality of load space candidates.

In addition, when a transportation distance of a first load of a plurality of loads is longer than a transportation distance of a second load of the plurality of loads, the extraction unit 13 may extract the load space of each of the first and second loads such that the distance from the carrying-in and out location of the load space extracted with respect to the second load becomes shorter than the distance from the carrying-in and out location of the load space extracted with respect to the first load.

For example, when, as a result of the load space extracting processing with respect to the plurality of loads, the plurality of loads (the first load and the second load) are assigned to one load space in a competitive manner and the transportation distance of the first load is longer than the transportation distance of the second load, the extraction unit 13 may extract the load space adjacent to the one load space in a direction, in which the distance from the carrying-in and out location becomes far, with respect to the first load or may extract the load space adjacent to the one load space in a direction, in which the distance from the carrying-in and out location becomes closer, with respect to the second load.

Note that, the distance information of each load may be acquired by the acquisition unit 12 based on the information about the loading location and the unloading location of each load. Specifically, the correspondence information, in which a combination of the loading location and the unloading location is associated with the transportation distance, may be set in advance in the storage means accessible by the loading support device 10, and the acquisition unit 12 may refer to the correspondence information and may acquire the distance information indicating the transportation distance based on the information about the loading location and the unloading location of each load.

Referring again to FIG. 2, the output unit 14 outputs the loading information in which the load ID of the load is associated with the load space ID of the load space extracted by the extraction unit 13 based on the desired information of the load.

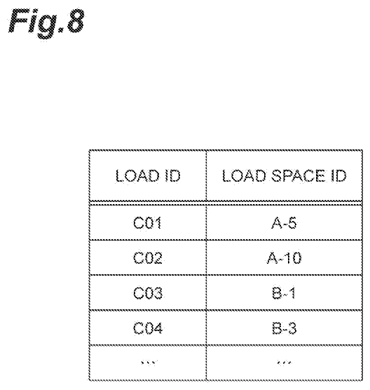

FIG. 8 is a diagram illustrating an example of a configuration of the loading information and data stored therein. As illustrated in FIG. 8, the loading information includes the load space ID associated with the load ID. For example, a load space having a load space ID “A-5” is assigned to the load having the load ID “C01”.

The output unit 14 outputs, for example, the loading information to the terminal 20. When a driver of the vehicle, who is a transporter, refers to the output loading information, a reduction in time and labor for a loading work is realized.

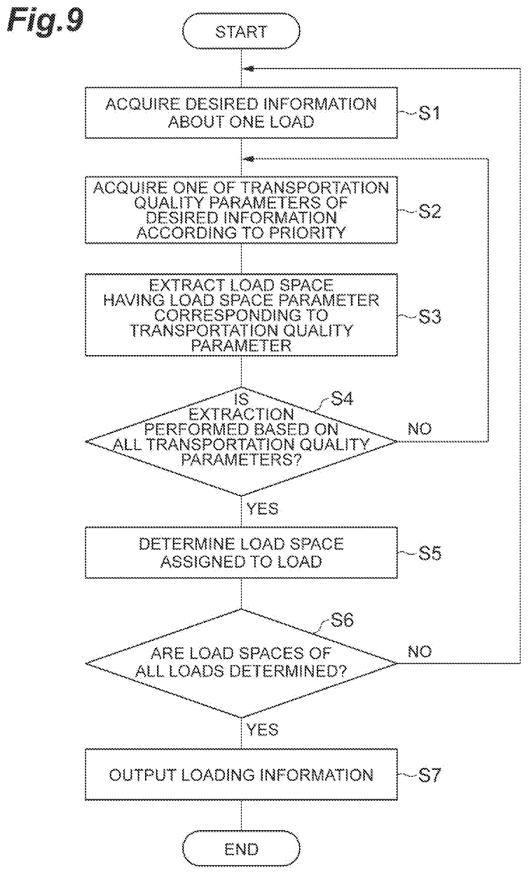

Subsequently, an operation of the loading support device 10 of the embodiment will be described with reference to FIG. 9. FIG. 9 is a flowchart illustrating processing content of a loading support method performed in the loading support device 10.

In step S1, the acquisition unit 12 acquires the desired information of the one load. The desired information is included, for example, in the load information stored in the load information storage unit 16.

In step S2, the extraction unit 13 acquires one of the plurality of transportation quality parameters included in the desired information according to the priority set for each transportation quality parameter.

In step S3, the load space ID having the load space parameter corresponding to the transportation quality parameter acquired in step S2 is extracted with reference to the load space information.

In step S4, the extraction unit 13 determines whether or not the load space is extracted based on all the transportation quality parameters included in the desired information. When it is determined that the extraction processing is performed based on all the transportation quality parameters, the process proceeds to step S5. On the other hand, when it is not determined that the extraction processing is performed based on all the transportation quality parameters, the process returns to step S2.

In step S5, based on the extraction processing in steps S2 to S4 repeated by the number of transportation quality parameters, the extraction unit 13 determines the load space (load space ID) to be assigned to the one load from which the desired information is acquired in step S1.

In step S6, the loading support device 10 determines whether or not the load space of all the loads which are targets to be loaded. When it is determined that the load space of all the loads is determined, the process proceeds to step S7. On the other hand, when it is not determined that the load space of all the load is determined, the process returns to step S1.

In step S7, the output unit 14 outputs loading information in which the load ID of the load is associated with the load space ID.

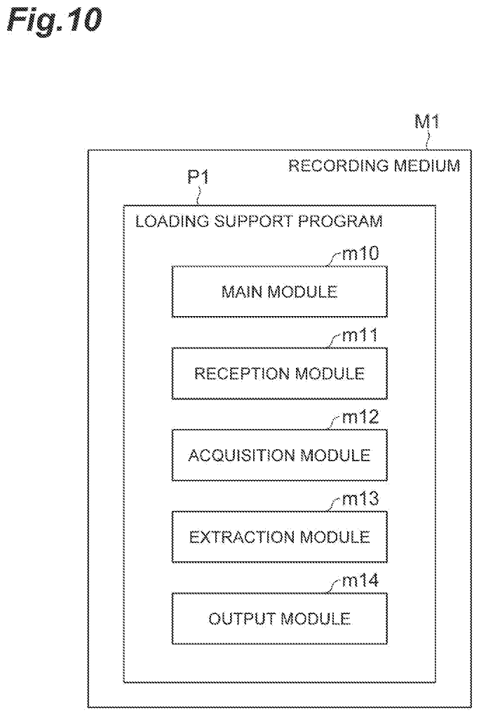

Subsequently, a loading support program for causing a computer to function as the loading support device 10 will be described with reference to FIG. 10. The loading support program P1 includes a main module m10, a reception module m11, an acquisition module m12, an extraction module m13, and an output module m14.

The main module m10 is a part that comprehensively controls loading support processing. When the reception module m11, the acquisition module m12, the extraction module m13, and the output module m14 are executed, the functions of the reception unit 11, the acquisition unit 12, the extraction unit 13, and the output unit 14 of the loading support device 10 illustrated in FIG. 2 are realized.

The loading support program P1 is provided by a storage medium M1 such as a magnetic disk, an optical disk, or a semiconductor memory. Further, the loading support program P1 may be provided through a communication network as a computer data signal superimposed on a carrier wave.

According to the loading support device 10, the loading support method, and the loading support program P1 of the above-described embodiment, the desired information including the transportation quality parameters relevant to a transportation target load is acquired based on the input of the user who is the shipper, and a load space having the load space parameters corresponding to the acquired transportation quality parameters is extracted. Therefore, it is possible to assign the load space having a transportation quality desired for the shipper to the transportation target load. In addition, since the loading information in which the load ID of the load is associated with the load space ID of the load space assigned to the load is output, the transporter refers to the loading information, and thus reduction in time and labor for a loading work is realized.

Hereinabove, the present disclosure has been described in detail based on the embodiments. However, the present disclosure is not limited to the above embodiment. The present disclosure can be variously modified without departing from the gist of the present disclosure.

What is claimed is:

1. A loading support system, which supports loading of a load into a load compartment of a vehicle, the loading support system comprising:
an acquisition unit configured to acquire load information in which a load ID for identifying the load is associated with desired information relevant to transportation of the load, the desired information including at least one transportation quality parameter relevant to a transportation quality of the load;
an extraction unit configured to, while referring to load space information, in which a load space ID, assigned to each of a plurality of load spaces formed by performing virtual division on a carrying space in which the load is carried on the load compartment, is associated with a load space parameter which is a parameter relevant to a transportation quality of each load space, extract the load space having the load space parameter corresponding to the transportation quality parameter included in the desired information of each load; and
an output unit configured to output loading information in which the load ID of the load is associated with the load space ID of the load space extracted by the extraction unit based on the desired information of the load.

2. The loading support system according to claim 1,
wherein the desired information includes a plurality of transportation quality parameters, and
wherein the extraction unit is configured to extract the load space having the load space parameter corresponding to each of the plurality of transportation quality parameters included in the desired information.

3. The loading support system according to claim 1,
wherein the desired information includes, as the transportation quality parameter, at least one of a temperature parameter indicating a magnitude of a temperature change during transportation, a vibration parameter indicating a magnitude of vibration during the transportation, and a fee parameter indicating a level of a transportation fee, and
wherein the load space parameter includes a parameter corresponding to the transportation quality parameter.

4. The loading support system according to claim 1,
wherein the desired information includes distance information relevant to a transportation distance of the load,
wherein the load space information includes information according to a distance from a carrying-in and out location of the load compartment of each load space, and
wherein the extraction unit is configured to, when a transportation distance of a first load of a plurality of loads is longer than a transportation distance of a second load of the plurality of loads, extract respective load spaces of the first load and the second load such that a distance from a carrying-in and out location of a load space extracted with respect to the second load becomes shorter than a distance from a carrying-in and out location of a load space extracted with respect to the first load.

5. The loading support system according to claim 4,
wherein the acquisition unit is configured to acquire information about a loading location and an unloading location of the load, and acquires the distance information based on the information about the loading location and the unloading location.

6. A loading support method in a loading support system which supports loading of a load into a load compartment of a vehicle, the loading support method comprising:
acquiring load information in which a load ID for identifying the load is associated with desired information relevant to transportation of the load, the desired information including at least one transportation quality parameter relevant to a transportation quality of the load;
while referring to load space information, in which a load space ID, assigned to each of a plurality of load spaces formed by performing virtual division on a carrying space in which the load is carried on the load compartment, is associated with a load space parameter which is a parameter relevant to a transportation quality of each load space, extracting the load space having the load space parameter corresponding to the transportation quality parameter included in the desired information of each load; and
outputting loading information in which the load ID of the load is associated with the load space ID of the load space extracted by the extracting based on the desired information of the load.
